(19) United States
(12) Patent Application Publication
(10) Pub. No.: US 2014/0146934 A1
(43) Pub. Date: May 29, 2014

(54) Compact Liquid Metal Cooled Spherical Fast Neutron Reactor Core Design

(71) Applicant: Robert M. Daily, III, Swan Point, MD (US)

(72) Inventor: Robert M. Daily, III, Swan Point, MD (US)

(21) Appl. No.: 13/689,702

(22) Filed: Nov. 29, 2012

(51) Int. Cl. G21C 1/02

(52) U.S. Cl. CPC G21C 1/022
USPC 376/351

(57) ABSTRACT

The present invention provides a design for a compact liquid metal cooled fast neutron nuclear reactor core. The design incorporates a single spherical fuel element with a subcritical mass. The spherical fuel element is brought to critically through the use of a plurality of adjustable concave neutron reflector panels. This novel nuclear reactor core configuration represents a simplified, compact and economical design.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC

Not Applicable

### BACKGROUND OF THE INVENTION

Nuclear reactors can be classified in a number of ways. Nuclear fission reactors are primarily classified as either thermal or fast Neutron reactors. In addition, nuclear reactors can be classified according to their cooling configuration or the configuration of the fuel element.

A thermal reactor requires a moderator such as heavy water, ordinary (light) water or graphite to scatter the emitted neutrons. The scattering takes place until the speed of the neutron slows down and approaches the average kinetic energy of the atoms in the surrounding moderator. The slower (thermal) speed of the neutron allows for a higher probability of fission when it collides with a uranium-235 atom. Most power reactors are of this type.

In fast neutron reactors, the fission chain reaction is sustained by neutrons at speeds above thermal levels. This type of reactor needs no neutron moderator. The reactor must use fuel that is relatively rich in fissile material compared to that found in thermal reactors. The primary advantage of this type of reactor is that it dramatically reduces the amount of nuclear waste that is generated. This is due to the fast neutrons having a higher ratio of splitting to capture of the plutonium or minor actinide atoms compared to that of thermal neutrons. This results in a more complete burning of the nuclear fuel and a reduction in the half-lives of the remaining waste from tens of millennia to a few centuries.

Nuclear reactors can also be classified according to the coolant configuration in the reactor core. Currently, there are five general types of reactor core cooling configurations: Pressurized Water Reactor (PWR), Boiling Water Reactor (BWR), Molten Salt Reactors (MSR), Gas Cooled Reactors (AGR) and Liquid Metal Fast Reactors (LMFR).

Pressurized Water Reactors (PWR) are thermal neutron type reactors that use ordinary water that is superheated and under high pressure as both a coolant and moderator. The water surrounds the nuclear fuel which is part of the primary cooling loop. The superheated, high pressure water is then sent to a heat exchanger where steam is created in a secondary loop. This steam is then conditioned and sent to a turbine that powers a generator to produce electricity or to power a propeller shaft of a naval vessel. This coolant configuration is the most common type of power generating reactor.

Boiling Water Reactors (BWR) are thermal neutron type reactors which utilize a two-phase fluid flow (water and steam) in the upper part of the reactor core. Ordinary water is used to conduct heat away from the core as steam. This steam is piped directly to the turbine which powers the electrical generator. There is no steam generator or heat exchanger in the loop as in a PWR. The exhaust steam is sent to a condenser where it is converted into a liquid. This liquid is pumped to a feed water heater where its temperature is raised before is it returned to the reactor core.

A Molten Salt Reactor (MSR) is a type of nuclear reactor in which the primary coolant is a molten salt mixture. In a number of designs, uranium tetrafluoride fuel is dissolved into the molten salt mixture. The liquid fuel reaches criticality when exposed to graphite inside the core. In order to capture higher thermodynamic efficiencies, MSRs operate at higher temperatures than water cooled reactors. An important advantage of MSRs is that the molten salt mixture operates at near atmospheric pressures.

A Gas Cooled Reactor (GCR) uses helium, nitrogen or carbon dioxide as the primary coolant. Graphite is used as the moderator. An advantage of this type of design is that natural uranium (0.7% uranium-235 and 99.3% uranium-238) can be used as a fuel. This reduces the complexity of the fuel fabrication process compared to the use of enriched uranium.

A Liquid Metal Fast Reactor (LMFR) is a type of nuclear reactor where the coolant is liquid metal. The liquid metals used include sodium, mercury, lead, a lead-bismuth eutectic or sodium-potassium alloy. Liquid metals have advantages such as the reactor core not being under pressure and it having a much higher power density. This simplifies the reactor design and improves system safety. The liquid metal is heated by the reactor core and it is then sent to a heat exchanger. In the heat exchanger a secondary loop containing water is superheated, conditioned and then sent to a turbine which powers an electrical generator or to provide power to a propeller shaft of a naval vessel.

Another way to classify nuclear reactors is by the fuel element configuration. By far the most common configuration today is the Fuel Rod Bundle. Another type of fuel element configuration is the Pebble-Bed design. Pebble-Bed Reactors are a relatively new type of experimental fuel element configuration.

The Fuel Rod Bundle design is the most common configuration in use today. In most of the PWR and BWR nuclear reactors in operation, the fuel is formed into 1 cm diameter by 1.5 cm long cylindrical pellets. PWR and BWR reactors are similar in that the pellets are stacked into zirconium metal alloy tubes that are approximately 4 meters long. 200 to 300 of these tubes are grouped into fuel assemblies. A large reactor will have approximately 150 to 200 fuel assemblies with approximately 80 to 100 tons of uranium.

A Pebble-Bed Reactor (PBR) is a graphite moderated, gas-cooled nuclear reactor that operates at a very high temperature. The core of the reactor consists of a large number of spherical fuel elements called pebbles. These tennis ball sized pebbles are made of pyrolytic graphite. Embedded within the graphite are thousands of small fuel particles containing a fissile material (usually uranium) surrounded by a layer of silicon carbide. Thousands of these pebbles are located in the core of the reactor and they are cooled by an inert or semi-inert gas such as helium, nitrogen or carbon dioxide. As the fuel within the pebbles is consumed, the pebbles gradually make their way to the bottom of the reactor vessel where they are eventually collected at the bottom of the reactor while new pebbles are added to the top.

The purpose of the present invention is to provide a novel nuclear reactor core design. The present invention differs significantly from previous nuclear reactor core designs by dramatically reducing the size and complexity of the reactor core. It also differs in its use of a single subcritical mass spherical fuel element. In addition, the present invention does not use neutron absorbing control rods. This is a departure from previous design paradigms. The present invention's small modular design is intended to provide small scale electrical power generation for remote locations, small scale steam generation and naval propulsion.

### BRIEF SUMMARY OF THE INVENTION

The present invention consists of a spherical reactor vessel housing a single spherical fuel element. The fuel element is located in the center of the reactor vessel. The fuel element is held in place by six fixed support rods made of zirconium alloy or other high strength material that is translucent to neutrons and has a high melting temperature. The rods are placed orthogonally about the interior of the reactor vessel and they extend radially inward toward the spherical fuel element. The interior end of each rod, except for the top rod, has a tapered, rounded tip. The interior end of the top rod is treaded so that it can be rigidly attached to the spherical fuel element. The bottom rod is fixed permanently to the bottom of the reactor vessel and it extends vertically up to the fuel element. Four rods are arranged at 90 degree intervals along a plane that extends horizontally through both the spherical reactor vessel and the spherical fuel element.

All six rods provide structural support for the spherical fuel element as well as providing a means to guide each of six neutron reflector panels. The reflector panels are made of a high strength, high melting point material, such as tungsten carbide, that is a good reflector of neutrons. The neutron reflector panels have a concave shape in order to focus the reflected neutron flux on to the spherical fuel element. The neutron reflector panels are attached to a moveable support structure. The support structures have a channel through which the support rods pass. The support structure allows the neutron reflector panels to move in and out radially along support rods.

By moving the neutron reflectors closer to or farther from the spherical fuel element, the power level of the reactor core can be precisely controlled. In a fast neutron reactor, sustaining a fission reaction requires a highly enriched uranium or plutonium fuel. In fast neutron reactors, criticality is reliant on delayed neutrons. Control is achieved by modulating the reflected delayed neutron flux level. Each of the six neutron reflector panels is independently adjustable in order to mitigate the effects of any structural asymmetries within the fuel element, provide increased power level control fidelity and to eliminate any common mode failure scenarios within the neutron reflector panel control system.

In a preferred embodiment, the spherical fuel element, support rods and neutron reflector panel control structure are immersed inside the reactor core in a lead-bismuth eutectic coolant mixture. When the neutron reflector panels are placed in close proximity to the spherical fuel element, the fuel element is brought to criticality by the presence of the reflected neutrons. The lead-bismuth eutectic coolant mixture is then heated by the fuel element to a temperature of approximately 530° C.

In the preferred embodiment, the liquid metal coolant is brought into contact with a heat exchanger that is located inside the reactor core. The heat exchanger transfers the reactor core heat to a secondary heat exchange loop. In the secondary heat exchanger, the secondary coolant converts ordinary water to steam which is then used to power a steam turbine or naval propulsion unit.

In another embodiment, the lead-bismuth eutectic coolant mixture is circulated out of the reactor vessel by mechanical or electromagnetic pumps to an external heat exchanger. In the heat exchanger, the lead-bismuth eutectic mixture converts ordinary water to steam which is then used to power a steam turbine or naval propulsion unit. The lead-bismuth eutectic coolant is then circulated back to the reactor core by mechanical or electromagnetic pumps at a temperature of approximately 400° C. where the primary loop heat cycle is repeated. When the reactor is shut down, the lead-bismuth eutectic coolant mixture of 44.5% lead and 55.5% bismuth will begin to solidify as the reactor core temperature decreases below 123.5° C. Inside the reactor vessel is a plurality of heater elements. These heater elements are necessary in order to melt the solid lead-bismuth eutectic coolant mixture during the initial startup phase.

The present invention differs from all previous nuclear reactor designs in that it contains only one fuel element. The size of this fuel element is such that it has a subcritical mass for the given nuclear material. Furthermore, there is no moderating material to slow down fast neutrons to thermal speeds. In addition, there are no containment rods or assemblies to capture neutrons in order to regulate the nuclear reaction process. In the present invention, the nuclear reaction process is regulated by modulating the proximity of a plurality of neutron reflector panels positioned within the reactor core.

### BRIEF DESCRIPTION OF THE SEVERAL VIEWS OF THE DRAWING

FIG. 1 is a cross-sectional side view of the reactor core.

FIG. 2 is a cross-sectional top view of the reactor core.

FIG. 3 is close-up view of the spherical fuel element shown in FIGS. 1 and 2.

FIG. 4 is the spherical fuel element.

FIG. 5 is a sectional view, with parts cut away, showing the top neutron reflector control assembly with the spherical fuel element attached.

FIG. 6 is a sectional view, with parts cut away, showing one of the four side quadrant neutron reflector control assemblies.

FIG. 7 is a sectional view, with parts cut away, showing the bottom neutron reflector control assembly.

### DETAILED DESCRIPTION OF THE INVENTION

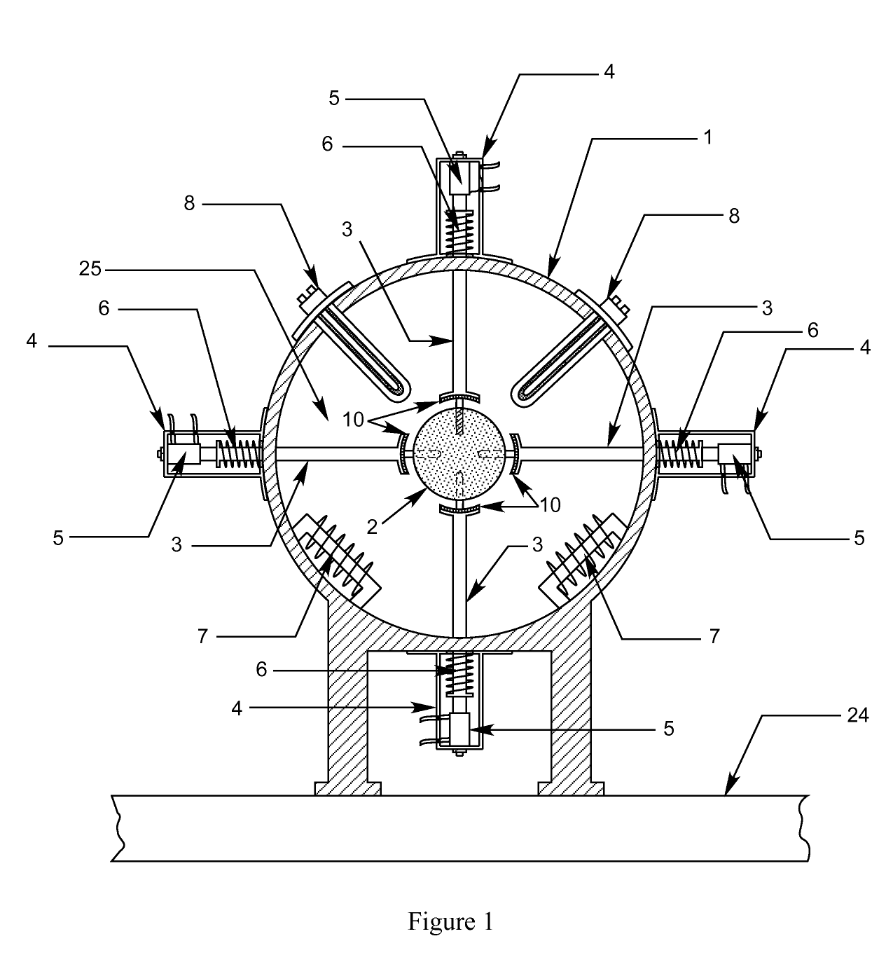

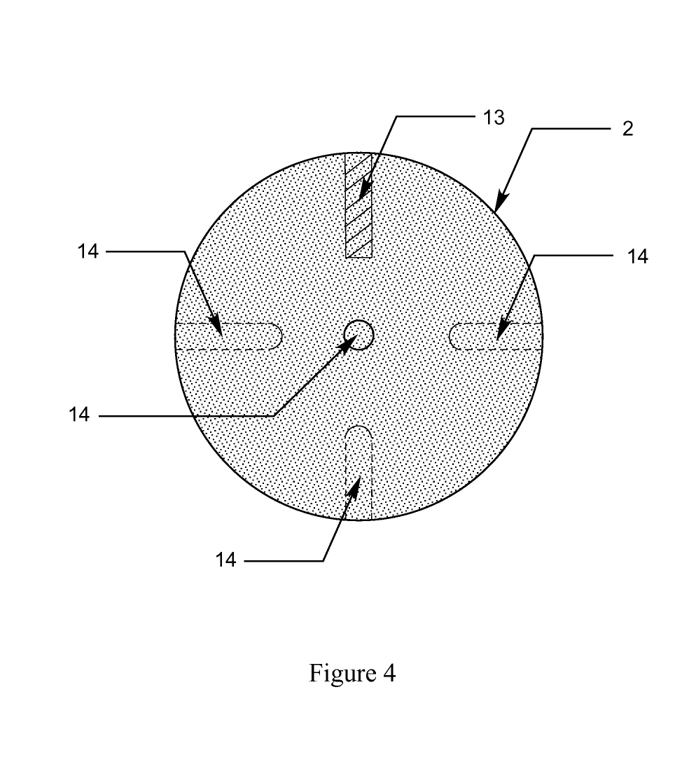

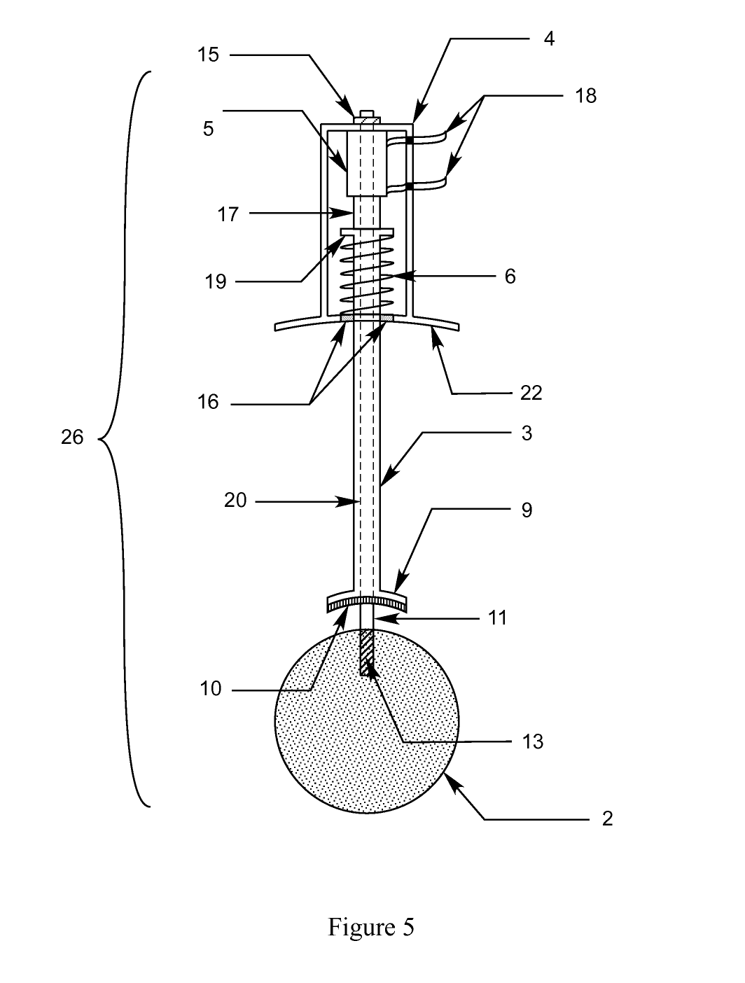

FIG. 1 is a cross-sectional view of the reactor vessel 1 which is mounted to a subfloor 24. At the center of the reactor core 25 is the spherical fuel element 2. The fuel element 2 is surrounded by a plurality of concave neutron reflectors 10 which are mounted to reflector mounting assemblies 3. These reflector mounting assemblies 3 move along fixed support rods 11,12 (as shown in FIGS. 5, 6 and 7) which extend from the outside of the reactor vessel 1 to slots 13,14 (as shown in FIG. 4) within the spherical fuel assembly 2.

Mounted along the outside of the reactor vessel 1 is a plurality of reflector control housings 4. These housings 4 contain a bidirectional hydraulic piston assembly 5, spring 6 and the top of the reflector mounting assembly 3. The hydraulic piston assembly 5 pushes and pulls the reflector mounting assembly 3 inward and outward, respectively, along the fixed support rod 11,12 (as shown in FIGS. 5, 6 and 7). The spring 6 acts to oppose the hydraulic piston assembly 5 in order to pull the reflector mounting assembly 3 outward along the fixed support rod 11,12 (as shown in FIGS. 5, 6 and 7).

Mounted within the reactor core 25 is a plurality of heater assemblies 7 which are used to melt the metal coolant during a cold startup.

Mounted on the outside of the reactor vessel 1 and extending into the reactor core 25 is a plurality of heat exchangers 8. These heat exchangers 8 transfer the heat from the reactor core 25 to a secondary working fluid.

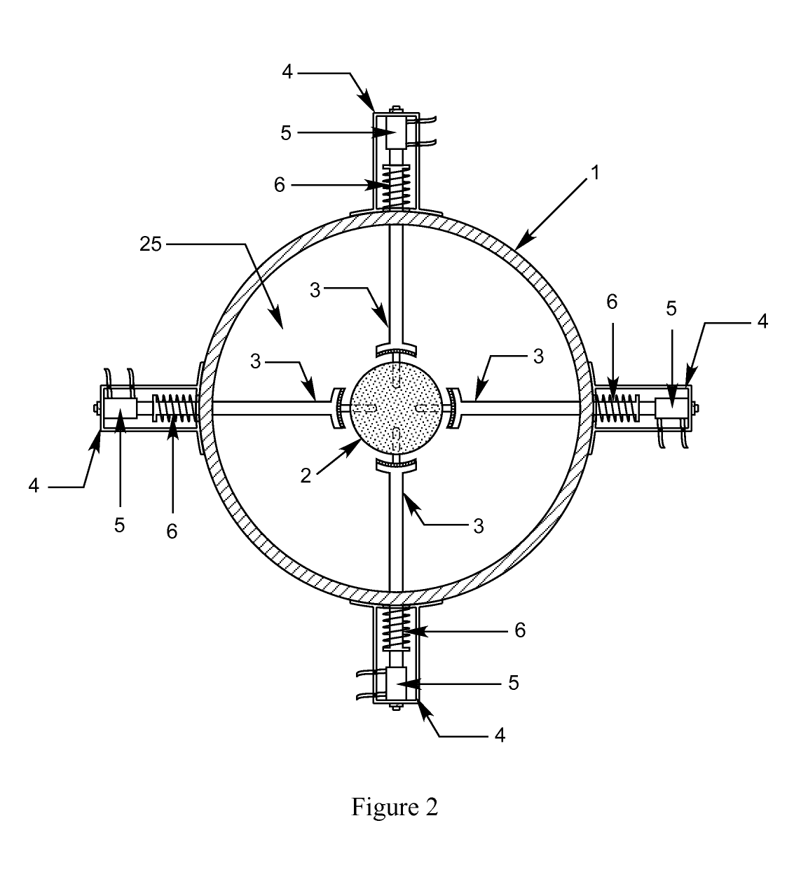

FIG. 2 is cross-sectional view top view of the reactor core 25. At the center of the reactor core 25 is the spherical fuel element 2. The fuel element 2 is surrounded by a plurality of concave neutron reflectors 10 which are mounted on reflector mounting assemblies 3. These reflector mounting assemblies 3 each move along a fixed support rod 12 which extends from the outside of the reactor vessel 1 to slots 14 (as shown in FIG. 4) within the spherical fuel assembly 2.

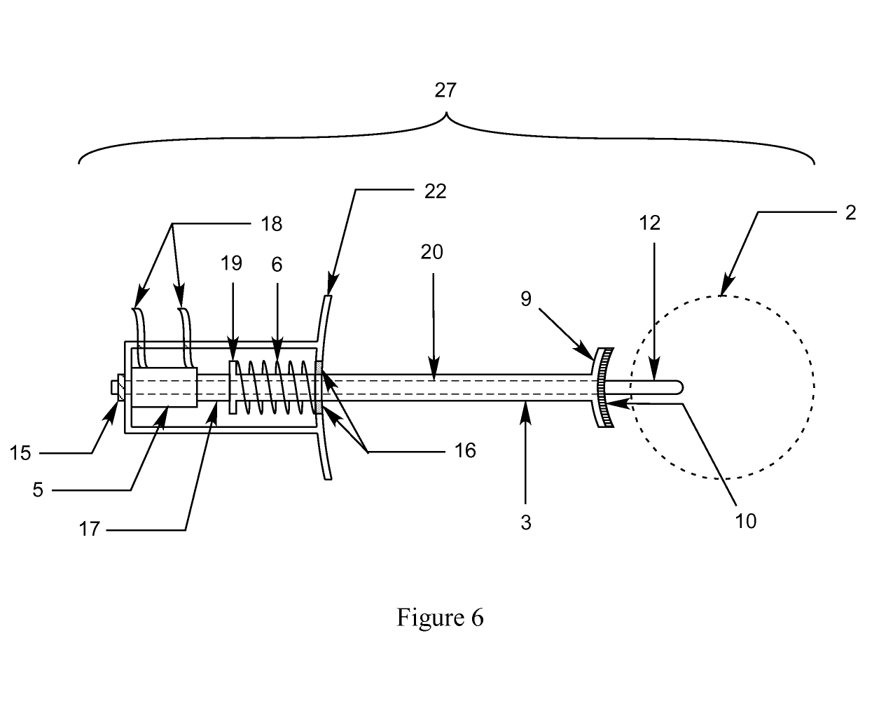

Mounted along the outside the reactor vessel 1 is a plurality of reflector control housings 4. These housings 4 contain a hydraulic piston assembly 5, spring 6 and the top part of the reflector mounting assembly 3. The hydraulic piston assembly 5 pushes and pulls the reflector mounting assembly 3 inward and outward, respectively, along the fixed support rod 12 (as shown in FIG. 6). The spring 6 acts to oppose the hydraulic piston assembly 5 in order to pull the reflector mounting assembly 3 outward along the fixed support rod 12 (as shown in FIG. 6).

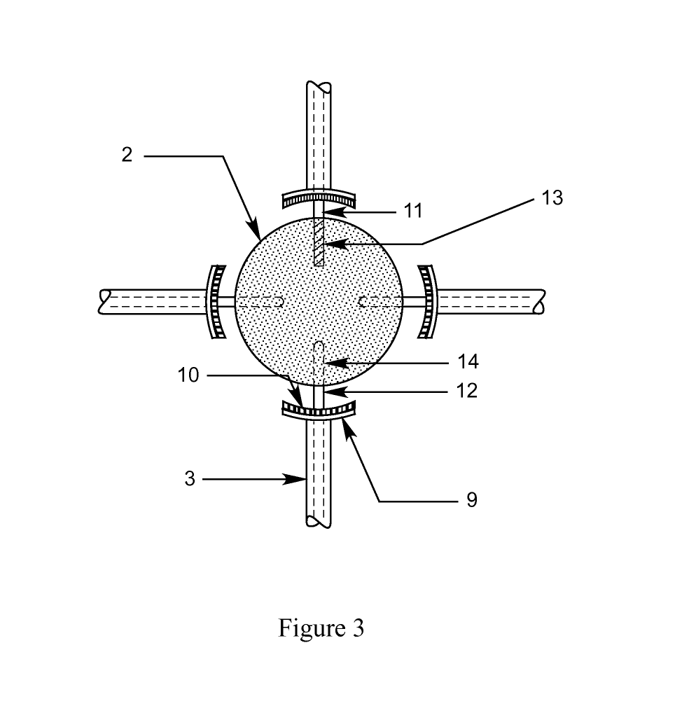

FIG. 3 is close-up view of the spherical fuel element 2 with parts cut away. Surrounding the fuel element 2 is a plurality of concave neutron reflectors 10. These reflectors 10 are each mounted on a curved flange 9 which is on the bottom part of the reflector mounting assembly 3. Each of the reflector mounting assemblies 3 moves along fixed support rods 11,12. These support rods 11,12 extend into slots 13,14 within the spherical fuel element 2 in order to hold it securely in place within the reactor core 25 (as shown in FIGS. 1 and 2).

FIG. 4 is a spherical fuel element 2 . The fuel element 2 contains six slots 13, 14. Within the fuel element 2 are four smooth slots 14 located equidistant along the horizontal axis. One smooth slot 14 is located on the quadrant bottom of the fuel element 2. A sixth threaded slot 13 is located on the top quadrant of the fuel element 2.

FIG. 5 is a sectional view, with parts cut away, showing the top neutron reflector control assembly 26 with the spherical fuel element 2 attached. The spherical fuel element 2 is attached to a fixed support rod 11 by a threaded slot 13. The opposite end of the support rod 11 is secured to the top of the reflector control housing 4 by a retaining ring 15.

Surrounding the support rod 11 is a reflector mounting assembly 3 with a hollow channel 20. The reflector mounting assembly 3 extends into the reflector control housing 4. A neutron reflector 10 is attached to the bottom curved portion 9 of the reflector mounting assembly 3. The reflector control housing 4 contains a curved flange 22 which attaches to the outside of the reactor core vessel 1 (as shown in FIGS. 1 and 2).

Within the reflector control housing 4 is a bidirectional hydraulic piston assembly 5. Extending out of the hollow hydraulic piston assembly 5 is a hollow piston 17 through which the fixed support rod 11 extends. Also extending out of the hydraulic piston assembly 5 is a plurality of hydraulic control lines 18. Hydraulic oil passes through the hydraulic control lines 18 and controls the direction of the piston 17. The piston 17 contacts the flanged top 19 of the reflector mounting assembly 3. Attached between the bottom of the reflector mounting assembly flange 19 and the control housing seal 16 is a high tension spring 6.

FIG. 6 is a sectional view, with parts cut away, showing one of the four side quadrant neutron reflector control assemblies 27. A fixed support rod 12 extends from the outside of the reactor vessel 1 shown in FIGS. 1 and 2, through the reflector control housing 4, through the center channel of the reflector mounting assembly 20 and into the spherical fuel element 2. The opposite end of the support rod 12 is secured to the top of the reflector control housing 4 by a retaining ring 15.

A neutron reflector 10 is attached to the curved bottom 9 of the reflector mounting assembly 3. The reflector control housing 4 contains a curved flange 22 which attaches to the outside of the reactor core vessel 1 as shown in FIGS. 1 and 2.

Within the reflector control housing 4 is a bidirectional hydraulic piston assembly 5. Extending out of the hollow hydraulic piston assembly 5 is a hollow piston 17 through which the fixed support rod 12 extends. Also extending out of the hydraulic piston assembly 5 is a plurality of hydraulic control lines 18. Hydraulic oil passes through the hydraulic control lines 18 and controls the direction of the piston 17.

The piston 17 contacts the flanged top 19 of the reflector mounting assembly 3. Attached between the reflector mounting assembly flange 19 and the control housing seal 16 is a high tension spring 6.

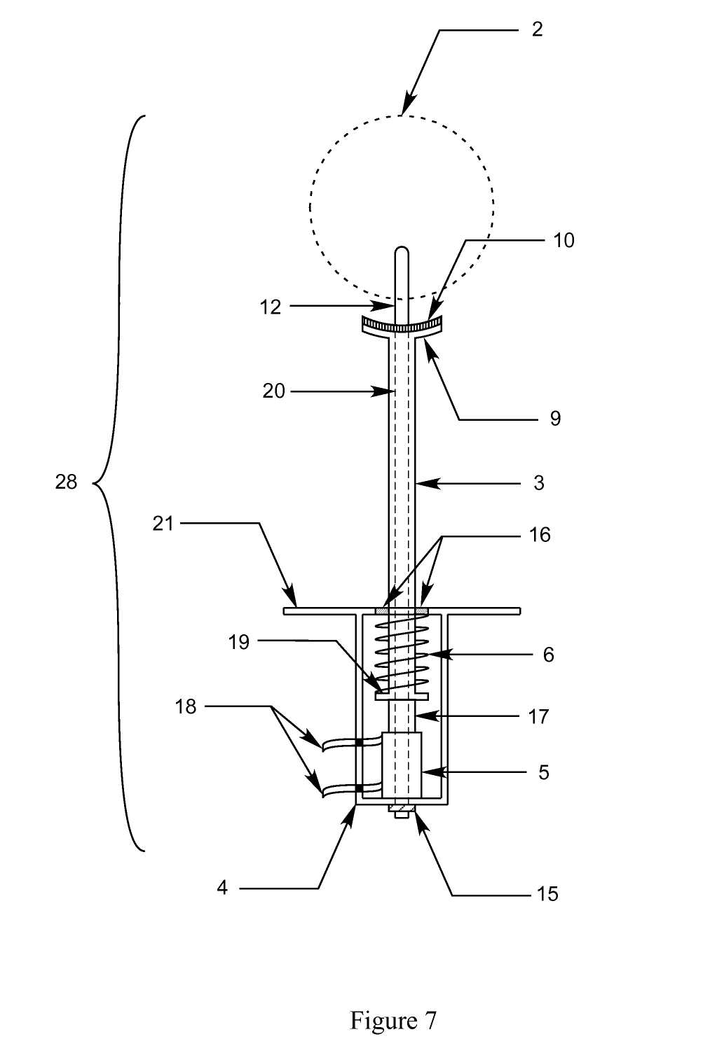

FIG. 7 is a sectional view, with parts cut away, showing the bottom neutron reflector control assembly 28. A fixed support rod 12 extends from the outside of the reactor vessel 1 as shown in FIGS. 1 and 2, through the bottom reflector control housing 23, through the center channel 20 of the reflector mounting assembly 3 and into the spherical fuel element 2. The opposite end of the support rod 12 is secured to the top of the reflector control housing 4 by a retaining ring 15. A neutron reflector 10 is attached to the curved bottom 9 of the reflector mounting assembly 3. The bottom reflector control housing 23 contains a flat flange 21 which attaches to the outside of the reactor core vessel 1 as shown in FIGS. 1 and 2.

Within the bottom reflector control housing 23 is a bidirectional hydraulic piston assembly 5. Extending out of the hollow hydraulic piston assembly 5 is a hollow piston 17 through which the fixed support rod 12 extends. Also extending out of the hydraulic piston assembly 5 is a plurality of hydraulic control lines 18. Hydraulic oil passes through the hydraulic control lines 18 and controls the direction of the piston 17.

The piston 17 contacts the flanged top 19 of the reflector mounting assembly 3. Attached between the bottom of the reflector mounting assembly flange 19 and the control housing seal 16 is a high tension spring 6.

What is claimed is:

1. A nuclear reactor core comprising a containment vessel, liquid coolant, a single spherical fuel element and a plurality of neutron reflectors.

2. In accordance with claim 1, the spherical fuel element is composed of a radioactive element or compound.

3. In accordance with claim 2, the spherical fuel element is of such a diameter that it is subcritical.

4. In accordance with claim 1, the neutron reflector is concave shaped toward the spherical fuel element.

5. In accordance with claim 1, the liquid metal coolant is composed of an element or compound that is translucent to neutrons.

6. In accordance with claim 1, further comprising a plurality of fixed support rods which supports a spherical fuel element which is suspended in the center of the containment vessel.

7. In accordance with claim 1, further comprising a plurality of moveable platforms on which the neutron reflectors are mounted.

8. In accordance with claim 6, each said fixed support rod also provides a platform upon which a moveable platform of claim 7 may transverse.
